(19) United States
(12) Patent Application Publication
(10) Pub. No.: US 2005/0279965 A1
(43) Pub. Date: Dec. 22, 2005

(54) WASTE OIL, WASTE PLASTIC, AND WASTE TIRE RECYCLING

(76) Inventors: Norman Arrison, Edmonton, Alberta (CA); Patrick J. Cochrane, Sherwood Park, Alberta (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 11/160,016

(22) Filed: Jun. 6, 2005

Related U.S. Application Data
(60) Provisional application No. 60/521,607, filed on Jun. 4, 2004.

(51) Int. Cl. C08L 95/00; E04B 1/74

(52) U.S. Cl. 252/62

(57) ABSTRACT

A method for producing composite products combines recycled tire crumb, shredded plastics and asphalt produced from waste and slop oil.

### FIELD OF INVENTION

The present invention relates to a method of recycling waste oil, waste plastic and tires into useful products.

### BACKGROUND OF THE INVENTION

Waste oil, waste plastic and used tires each present difficult disposal problems. It is often uneconomical to produce recycled products from these waste items and therefore recycling programs often must be subsidized in order to be viable.

Therefore, there is a need in the art for recycling methods for these waste items which may be economical and produce useful products in combination with one another.

### SUMMARY OF THE INVENTION

The present invention relates to a method of forming a composite product, comprising the steps of:
(a) producing a rubber crumb by recycling used tires;
(b) producing plastic particles from plastic materials;
(c) producing asphalt from waste oil or slop oil, or a combination of waste oil and slop oil;
(d) combining the rubber crumb, plastic particles and asphalt and forming a composite product.

In one embodiment, clay, sand, or gravel may also be mixed with the above materials to produce the composite product.

### BRIEF DESCRIPTION OF THE DRAWINGS

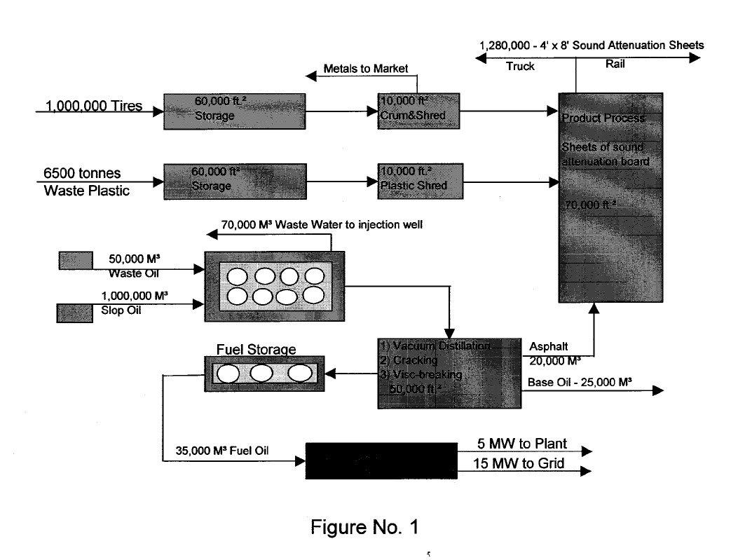

The present invention may now be described with reference to FIG. 1, which is a schematic depiction of one embodiment of a method of the present invention.

### DESCRIPTION OF THE INVENTION

The present invention provides for methods of recycling waste oil, waste plastic and used tires without the necessity of cleaning the materials because soil, clay and sand are often used in the mix along with fine gravel at times. When describing the present invention, all terms not defined herein have their common art-recognized meanings.

In general terms, the invention comprises a method of producing one or more of the following products: a fuel oil, a base oil, and composite products through recycling of used tires, plastics, waste oil and slop oil. In one embodiment, waste oil and slop oil are distilled, such as by vacuum distillation, cracked or otherwise treated to produce asphalt, fuel oil such as diesel, and base oil. The asphalt is combined with shredded plastic and rubber crumb produced from used tires to produce composite products. As used herein, “asphalt” means a bituminous cementitious material which is solid or semi-solid at room temperature and becomes less viscous as it is heated. Asphalt may be produced from residual hydrocarbons left after distillation of oil.

As used herein, a “composite product” is a product comprising two or more of plastic, rubber, asphalt, oil or other hydrocarbon and materials. Preferably, at least one of the plastic, rubber, asphalt, or oil component is obtained through a recycling process. In one embodiment, the composite product may comprise sound abatement sheets. The use of the sheets is not intended to limit the claimed invention. The composite products may be laid down on rocky beaches to protect boat bottoms and bathers feet while at the beach. The beach product preferably has sand and fine gravel added to give the composite a much higher density than water.

As shown in FIG. 1, three separate recycle streams are combined to produce a useful product. In a first stream, used tires are converted to rubber crumb using conventional methods well-known in the art. Non-rubber material in the tires, primarily metal or plastic belts are separated and removed. In a second stream, waste plastics are also shredded, optionally with light cleaning. As used herein, “plastics” include a wide range of synthetic or semi-synthetic organic condensation or polymerization products that can be molded or extruded into objects or films or fibers. Suitable plastics may include a wide range of materials, such as epoxy resins, polyacrylics, polycarbonates, polyethylenes (eg., PETE, HDPE, LDPE), polyolefins, polypropylene, polystyrene, polyurethanes, polyvinyl chloride, and vinyl plastics. In a third stream, a hydrocarbon stream is treated to produce asphalt, or an asphalt rich composition.

In the third stream, waste oil and slop oil are first separated from waste water and solids by conventional means such as with cyclones or other separators. The waste oil may comprise used motor oil, or other waste lubricating oil. The initial waste lubricating oil may initially be vacuum distilled to produce lube base oil. Approximately 50% of the waste lubricating oil may be converted to base oil. The base oil produced by vacuum distillation may then be treated by a specialized filter such as an activated alumina filter to make the lube oil meet an applicable health standards such as IARC (International Agency for Research on Cancer). Base oil includes a finished petroleum stock which is blended with other materials to make salable products such as motor oil or other lubricating oils.

The bottoms of the vacuum distillation column may then be refined, or mixed with slop oil (crude oil, emulsions, lard and cooking oil, oil field and tanker bottoms, bilge oil, waste wax, hydraulic oil, etc.) and the mixture may be refined to a gas oil or diesel and asphalt, using any known process. The production of gas oil or diesel and asphalt with standard refining technology is well-known to those skilled in the art, and need not be described herein.

Any produced gas or diesel oil may be used in a fuel in a power production plant to generate electricity to power the plant. As well, excess power may be sold to the power grid, enhancing the plant's economic efficiency.

The hot asphalt, which may be heated to the range of about 200° C. to about 295° C., may be combined with the shredded plastic and rubber crumb from the first and second streams in a high shear mixer. The temperature used depends on the product being manufactured. The combined components may then be formed into various products such as composite sheets. The composite sheets may also contain clay, sand or gravel to give the end product desired properties. The composition of the composite sheets may be varied by varying the properties of the recycled product streams. In particular, the plastics may be varied to produce such effects as density changes and hardness and wear characteristics. Paints and dyes may be added to colour the composite product. The composite sheets may be used as sound abatement boards, drive way repair sheets, movable parking lot pads and the like.

As will be apparent to those skilled in the art, various modifications, adaptations and variations of the foregoing specific disclosure can be made without departing from the scope of the invention claimed herein. The various features and elements of the described invention may be combined in a manner different from the combinations described or claimed herein, without departing from the scope of the invention.

1. A method of forming a composite product, comprising the steps of:
(a) producing a rubber crumb by recycling used tires;
(b) producing plastic particles from plastic materials;
(c) producing asphalt from waste oil or slop oil, or a combination of waste oil and slop oil;
(d) combining the rubber crumb, plastic particles and asphalt and forming a composite product.

2. The method of claim 1 further comprising the step of producing a gas oil or diesel oil in step (c).

3. The method of claim 1 further comprising the step of producing a base oil in step (c).

4. The method of claim 1 wherein the composite product is a sound attenuation board.

5. The method of claim 1 wherein the composite product further comprises clay, sand, or gravel.
